(19) United States
(12) Patent Application Publication
(10) Pub. No.: US 2010/0170942 A1
(43) Pub. Date: Jul. 8, 2010

(54) METHOD AND SYSTEM FOR INCREASING SECURITY IN THE CREATION OF ELECTRONIC SIGNATURES BY MEANS OF A CHIP CARD

(75) Inventor: Luigi Lo Iacono, Bonn (DE)

Correspondence Address: SUGHRUE MION, PLLC, 2100 PENNSYLVANIA AVENUE, N.W., SUITE 800, WASHINGTON, DC, 20037, US

(73) Assignee: NEC EUROPE LTD., Sankt Augustin (DE)

(21) Appl. No.: 12/521,097

(22) PCT Filed: Dec. 20, 2007
(86) PCT No.: PCT/EP2007/064321

§ 371 Date: Feb. 22, 2010

(30) Foreign Application Priority Data
Dec. 29, 2006 (DE) 10 2006 062 046.1

(51) Int. Cl. G06F 17/00; G06K 19/067; H04L 9/32; G06F 3/048

(52) U.S. Cl. 235/375; 235/492; 713/176; 715/784

(57) ABSTRACT

The present invention relates to a method and system for increasing security in digital signatures by means of chip card. The method and system of the invention in particular provide for a visual verification of the data to be designed and select essential data therefrom in order to ensure a reliable signing process. The method for increasing security in the digital signing of data with a chip card comprises the following steps: providing a chip card (5) with integrated display (51), providing a terminal (2) and a chip card reader/writer (4) for transmitting data to be signed from chip card (5) to terminal (2) and from the terminal to the chip card, respectively, establishing a data transmission between chip card (5) and terminal (2), with display (51) being substantially visible to the user during data transmission between terminal (2) and chip card (5), initiating a signature process, transmitting the data to be signed to chip card (5), with the essential data being marked, and selecting the marked data, representing the selected data on display (51) of the chip card, and signing the data to be signed, the signature being transmitted from chip card (5) to terminal (2).

The present invention relates to a method and a system for increasing security in the creation of electronic signatures by means of a chip card. The method or system of the invention provides in particular for a visual verification of the data to be signed to ensure a trustworthy signature.

Chip cards, often also called smart cards or Integrated Circuit Card (ICC), are special plastic cards with embedded chip which usually have a hardware logic, memory and/or a microprocessor. There are different types of chip cards.

Memory chip cards merely serve to store data. They have a simple logic only, whereas processor chip cards are usually provided with their own card operating system and often have cryptographic properties. Chip cards with cryptographic properties, in addition to the possibility of storing private information, such as cryptographic codes, also offer cryptographic algorithms, so that the encryption or the creation of electronic signatures only occurs within the chip card and the cryptographic codes can never be directly read.

Since the secrete or private codes are stored on the chip card and do not leave it, it is almost impossible to espy the code, for which reason the creation of a signature by means of a chip card must in principle be regarded as rather secure. Electronic signatures offer some advantages for transactions via networks, for example, they guarantee the authenticity of a message. Most Member States of the European Union have meanwhile passed laws on electronic signatures, thus complying with the requirements of EU Directive 1999/93/EC. In Germany and Europe, the electronic signature is largely legally equal with a signature by one's own hand. In view of the high security level offered by chip cards in the creation of electronic signatures, chip cards are mandatory under the German Signaturgesetz (SigG, German Electronic Signature Law) and the Signaturverordnung (SigV, Electronic Signature Ordinance), respectively, as so-called signature-creation devices for creating the electronic counterpart of a handwritten signature.

Since chip cards mostly have neither a power supply nor a keyboard or display, a card reader/writer as well as a terminal for displaying the data and interaction with a chip card will always be necessary. Consequently, for signing and displaying digital documents there must always be data communication between terminal and chip cards. Therefore, a signer must be able to rely on a trustworthy transfer and a trustworthy depiction of the data to know for sure that the data presented on the terminal display are really the data he wants to sign with his chip card, i.e. the user wants to sign what he sees (WYSIWYS—“What You See is What You Sign”). Data communication between terminal and chip card as well as the presentation of the data to be signed on the terminal display, however, harbour a potential risk that is often designated as “terminal problem” and briefly discussed in the following.

Often personal computers (PCs) serve as terminals, with the computer screen serving as terminal display. With terminals of this kind, a user or signatory cannot be sure that the data displayed on the computer screen are really the data he wants to sign. For example, there may be malicious software (malware; e.g. “trojans”) on the PC, with the malware changing or replacing the data on the PC so that a user though seeing on the computer screen the data he wants to sign, eventually signs data not displayed on the computer screen. The following example will further clarify this.

Let's assume that a user wants to enter a bank transfer on his private PC that is infected by malware without the user's knowledge. The malware may intercept the data to be signed and replace them by an altered bank transfer, e.g. a transfer to a foreign numbered account. Instead of the fraudulent transfer to the foreign numbered account the malware displays an error message on the computer screen so that the user cannot recognize that he has already signed the bank transfer to the foreign numbered account and thus has instructed/authorized/accepted payment.

The prior art suggests several possible methods and systems for preventing such misuse. For example, special-purpose terminals with own terminal display could prevent that any malware may enter the terminal. This, however, has the disadvantage that such terminals fulfil a specific purpose only and are therefore expensive.

It is therefore desirable to use PCs as terminals with display which are flexible and cost-effective, where it is possible to prevent fraudulent acts initiated by malware by additional safety measures.

Thus, DE 199 23 807 relates to a method for increasing security in case of digital signatures, which method is substantially based on a cryptographic coupling between an external display device and the chip card. For this purpose, the data are transferred via an encoded communication channel between display device and chip card. In particular, the chip card knows the public code of the display device and the display device knows the public code of the chip card. This method, however, does not offer effective protection against malware, such as Trojans. Once malware has entered the PC it may override the safe channel between PC and chip card, since such malware on the PC is able to manipulate almost everything and may access the encoded material which is stored on the PC for generating the protected channel.

The method of the invention for increasing data security is based on the use of chip cards with integrated display. The invention relates to a method which ensures, for example in an insecure and unreliable environment, that the data he actually signs are displayed to the user, i.e. the user signs the data that he really sees on the display of the chip card (genuine “WYSIWYS”). According to the invention this is achieved by using the display on the chip card as reliable display to check the data to be signed. In other words, the data to be signed by means of the chip card are directly represented on the chip card display. Since the chip card itself directly controls the display, and since it is not possible that malware enters the chip card, the chip card display is reliable.

In view of its rather low size that is determined by the size of the chip card, the display on the chip card can only display comparatively little information, in particular, the display mostly cannot display all data to be signed at the same time. Thus, according to the invention, the data to be signed are—where necessary—reduced to essential specific data, and only these reduced essential specific data are shown on the display. This inventive approach is based on the observation that when some essential data cannot be manipulated by an adversary without being noticed—a manipulation will be recognized by the lawful user on the reliable display of the chip card—there is no longer any basis or motivation for launching an attack. This can be clearly seen on the example of a bank transfer. Here essential data of the recipient of the transfer as well as the amount to be transferred can be viewed. If an adversary is no longer able to change these data to his benefit without being noticed, he will no longer have any motivation to do so. It depends on the respective application context, which data are shown on the display, and how these data are selected from the chip card.

It is an object of the present invention to provide a method, a chip card as well as a system for increasing security in the creation of electronic signatures by means of chip cards and preferably to overcome the above described disadvantages of the prior art.

The problem underlying the present invention is solved by the independent claims. The dependent claims describe further preferred embodiments and modifications of the present invention.

In the following, the terms digital signature and electronic signature are used synonymously, with emphasis on the definitions and terminology used in the German Signaturgesetz (SigG, German Electronic Signature Law). Here the term “electronic signature” is used and three types of signatures are defined. Relevant for the method and system of the present invention are essentially those signature types that are based on mathematical or cryptographic methods or algorithms and, in particular, the so-called “qualified signature”, which has legal effect.

Furthermore, the term “essential data” means data that are particularly important for the signature process. In other words, the essential data are partial data of the data to be signed that are particularly suitable to concisely characterize the data to be signed. In this connection it must be noted that the term “partial” data is not restricted to a part, but that even all the data to be signed may be selected as partial data, in particular when the data to be signed are comparatively few data that can be represented by the integrated chip card display. In case of a bank transfer the following may for example be selected as essential data: account number, bank identification code and amount. Further data describing the transfer process, such as a subject, may be disregarded when selecting the essential characteristic data, i.e. these data are not essential but may only be regarded as supplementary data. In other words, such data are to be regarded as essential data that are decisive or important or specific to the signature process.

In the following, two preferred embodiments of the inventive method are described in detail.

According to a first embodiment of the invention, a chip card is merely used for a single predetermined purpose (e.g. bank transactions). Thereby, the specific system determines the data formats and thus also the essential data displayed by the chip card. The (reduced) essential data in this case could be the account number, the bank identification code and the amount.

According to a second preferred embodiment, a multi-purpose chip card can be used for several purposes, e.g. for bank transactions, as alternative to a handwritten signature, etc. The essential features of the data are therefore differently defined for different applications of the chip-card. In this second inventive embodiment, the essential data of the data to be signed that are to be shown on the display of the chip card are marked and selected depending on the application. Marking and selection may occur automatically or be carried out by a user.

In either case, a processing means or a selection means is provided on the chip card, e.g. in form of hardware or software, in order to filter out the relevant or essential data from the data stream to be signed and to represent them on the chip card display.

According to the second embodiment, a particular order and mode of operation is observed so that the signature creation occurs correctly and according to signature standards and the signature created by the chip card may also be verified outside the chip card by already widespread signature verification components.

The method and system of the invention has the advantage that the signature clearance, e.g. by entering a signature PIN, will only occur after a visual verification of the displayed essential data.

The present invention also relates to a chip card for carrying out the improved method of the invention for increasing security in the creation of electronic signatures or in the digital signing of data. The chip card of the invention may be designed as contact chip card or contact-less chip card or as chip card which can be accessed both via a contact and a contact-less interface.

The chip card according to the invention has a display integrated in or on the chip card which is designed as large as possible to be able to display as much information as possible at the same time. The display may be provided on the front side and/or on the rear side. In case of contact chip cards where the typical gold contacts of the chip card module are arranged on the front side, a larger display may be provided on the rear side. The display may e.g. be based on organic display technology or plastics technology. All displays are suitable that are small enough to be provided on or in a chip card. The increase in security is in particular achieved by addressing the only interface to the display with the microprocessor of the chip card. Therefore, only data are shown that are processed by the chip card microprocessor. Consequently, the display integrated on or in the chip card is a reliable display.

Preferably, the chip card of the invention includes control elements, such as scroll buttons or a scroll pad. The control elements enable the user to scroll the data or information shown on the display.

The present invention also relates to a system for increasing security in the digital signature of data. The system of the invention preferably comprises a chip card of the invention and a chip card reader/writer adapted thereto, preferably with terminal and terminal display. A chip card reader/writer according to the present invention is preferably designed such that the display on the chip card remains visible even during communication between reader/writer and chip card. In contact chip cards this can be achieved by a transparent design of parts of the reader/writer so that the underlying display is still visible when the reader is connected to the chip card contacts. According to a further embodiment, the reader/writer may also have a recess which enables the user to see the chip card display even when the chip card has been inserted into the reader/writer.

Due to the comparatively small display on the chip card it is only possible to represent thereon a limited amount of data or information. Thus, an essential aspect of the present invention is intelligent data selection, i.e. from among the large amount of information data a small part is selected which is nevertheless sufficient to visualize to the user all important aspects of the data to be signed. The selected data are preferably essential parts of the data to be signed. According to one embodiment, the user himself can select the data he considers essential. According to a further preferred embodiment, the selection of the essential data is made automatically. This is particularly advantageous when the chip card is a chip card that is especially provided for a single particular process, such as bank transactions. Since for this particular process the essential data are already pre-defined, these pre-defined essential data can be automatically selected and subsequently shown on the chip card display.

Preferably, the selection is based on data marking, i.e. the marked data are selected and shown on the chip card display. The marking, i.e. the basis for selection, is preferably carried out by means of a pre-defined marker, preferably a text-based marker. Particularly preferred are text-based structural languages, such as XML.

In the following, a preferred embodiment of the present invention is described in detail with reference to the FIGURE.

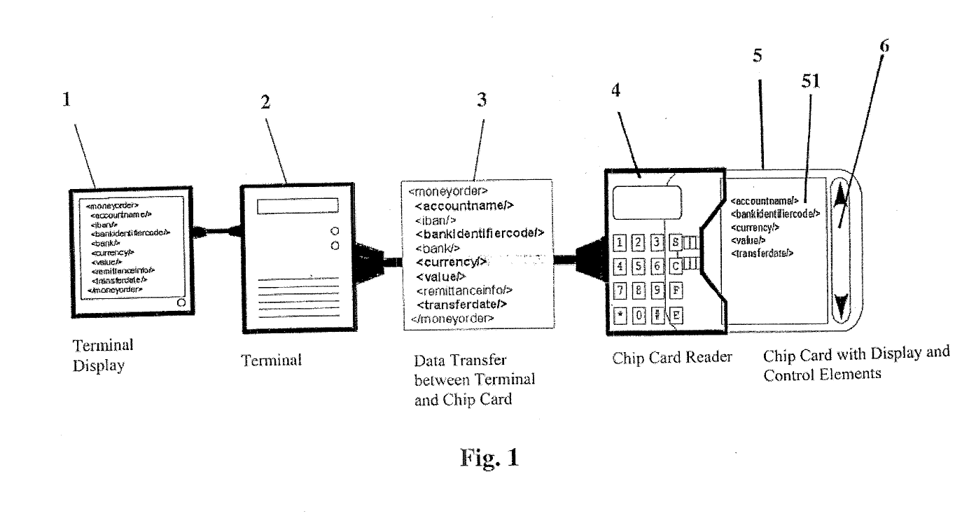

FIG. 1 shows a system of the invention for carrying out the signature process of the invention.

On the basis of FIG. 1, the bank transfer process already mentioned above in the prior art is described, here, however, using the method of the invention. In a bank transfer, for example, recipient, account number, bank identification code, amount and date may be selected as or considered to be the essential data. The display 5 integrated on the chip card therefore need not show all data necessary for executing the bank transfer, rather it is sufficient to show the essential data that characterize sufficiently exactly the transfer process to the user. On the basis of these essential data, a user himself is thus able to verify that the correct amount is transferred to the right person at the desired time. Thus, after a visual check of the data essential to him, a user can sign the bank transfer, i.e. confirm/instruct payment. If, for any reasons, the data are manipulated, for example, by malware in the terminal, according to the method of the invention these manipulated data are shown on display 5. A user will recognize this and therefore will not sign the manipulated data.

In the exemplary transfer process of FIG. 1, a terminal 2 and a terminal display 1 are provided. This may, for example, be done in a bank or train station, or the private PC serves as terminal 2 and the computer screen as terminal display 1. Furthermore, a chip card reader/writer 4 is provided for reading chip card 5. A user now introduces the chip card 5 into the reader/writer 4. Here it is sufficient when only the front part of the chip card 5 with the typical gold contacts is introduced into the reader/writer 4 to establish communication between the reader/writer and the chip card. The rear part of the chip card has a display 51 which remains visible even when the chip card is in communication connection with the reader/writer.

A user starts a bank transfer process wherein detailed data of the transfer process are shown on the terminal display. In addition, according to the method of the invention, data are communicated to the chip card 3 and a cryptographic hash value is calculated by means of a cryptographic hash function digesting the inputted data. A hash value is a scalar value of a fixed short length calculated from inputted data of any length and is sometimes also called the fingerprint of the message, since in view of the properties of cryptographic hash functions, the hash value clearly identifies the message.

After the user has authenticated himself as authorized user for the chip card, for example, by entering a personal identification number (PIN) or by scanning a biometrical feature, the electronic signature is calculated (by means of the hash value) on the chip card. This electronic signature is sent back from the chip card reader 4 to the terminal 2.

If all data are to be represented on the chip card display 51, no data set or the complete data set is marked and represented on the chip card display.

If only an essential part of the data to be signed is to be represented, the processor on the chip card 5 will search for marks in the data set, and the essential data are selected based on the marks. Unmarked data are directly transmitted to the hash function and are not represented on the chip card display 51. When a marked part is found in the data set, the mark (such as <moneyorder> or <iban>) is removed and the marked data are selected for representation on the display and transmitted without mark to the hash function. In other words, the hash value that is eventually signed is based on the data without marked text. In this connection, the process of the invention ensures in particular the order in which the data are fed into the hash function in order to maintain and support compatibility with standard signature verification components.

As a matter of course, the method of the invention may also be applied to other processes to be signed. For example, in a contract between two parties it is possible to represent only the essential data, such as the names of the contracting parties, the title of the contract, the date, and perhaps important language of the contract.

1. Method for increasing security in the creation of electronic signatures with a chip card (5) comprising the steps of:
a) providing a chip card (5) with integrated display (51),
b) providing a terminal (2) and a chip card reader/writer (4) for transmitting data to be signed from the chip card (5) to the terminal (2) and from the terminal to the chip card, respectively,
c) establishing data communication between the chip card (5) and the terminal (2), with the display (51) being substantially visible to the user during data communication between the terminal (2) and the chip card (5),
d) initiating a signature process,
e) transmitting to the chip card (5) the data to be signed wherein essential components may be characterized by marks,
f) selecting essential data from the data to be signed by means of a selection means on the chip card,
g) representing the selected data on the display (51) of the chip card, and
h) signing the data to be signed, with the signature being transmitted from the chip card (5) to the terminal (2).

2. Method for increasing security in the creation of electronic signatures with a chip card comprising the steps of:
providing a chip card (5) with integrated display (51), said chip card being adapted to a pre-determined signature process,
providing a chip card reader/writer (4) with visual access to the integrated chip card display (51), said chip card reader/writer being adapted to a pre-determined signature process,
establishing data transmission between the chip card reader/writer (4) and the chip card (5),
initiating the pre-determined signature process,
transmitting the data to be signed from the chip card reader/writer (4) to the chip card (5),
marking essential data from the data to be signed,
selecting the essential data based on the mark(s), the selection being performed by means of a selection means on the chip card itself,
representing these selected data on the display (51) of the chip card (5),
signing the data to be signed, with the signature being transmitted from the chip card (5) to the terminal (2).

3. Method according to claim 1, wherein, based on the data to be signed, a hash value is formed which is signed.

4. Method according to claim 3, wherein the hash value is based on the data to be signed without the marks.

5. Method according to claim 4, wherein the marks are removed for forming the hash value.

6. Method according to claim 1, wherein the step of marking and/or selecting is performed automatically for a pre-determined signature process.

7. Method according to claim 1, wherein the step of marking and/or selecting is performed manually for a signature process to be performed.

8. Method according to claim 1, wherein the step of scanning the transferred data for markers is performed between the step of initiating and the step of selecting, and the selection is based on the marks.

9. Method according to claim 8, wherein the marks are based on a text-based structural language, such as XML.

10. Chip card (5) with integrated display (51) for increasing security in the creation of electronic signatures, the chip card having a selection means which selects essential data from the data to be signed and represents said selected data on the integrated display (51).

11. Chip card according to claim 8, wherein the selection means selects the essential data based on the marks.

12. Chip card according to claim 8, wherein the chip card further comprises control elements (6), with which it is possible to control the scrolling of the display (51) on the chip card (5).

13. System for increasing security in the creation of electronic signatures with:
a) a chip card (5) according to claim 8, and
b) a chip card reader/writer (4) which is designed such that during data communication between chip card reader/writer (4) and chip card (5), the display (51) of the chip card (5) is at least partially visible.
